(19) United States
(12) Patent Application Publication
(10) Pub. No.: US 2025/0112283 A1
(43) Pub. Date: Apr. 3, 2025

(54) AQUEOUS ELECTROLYTE SOLUTION FOR PROTON BATTERY, AND PROTON BATTERY

(71) Applicant: TOYOTA JIDOSHA KABUSHIKI KAISHA, Toyota-shi (JP)

(72) Inventor: Hiroshi SUYAMA, Mishima-shi (JP)

(73) Assignee: TOYOTA JIDOSHA KABUSHIKI KAISHA, Toyota-shi (JP)

(21) Appl. No.: 18/796,544

(22) Filed: Aug. 7, 2024

(30) Foreign Application Priority Data
Sep. 28, 2023 (JP) 2023-167505

(51) Int. Cl. H01M 10/26

(52) U.S. Cl. CPC H01M 10/26; H01M 2300/0008

(57) ABSTRACT

An aqueous electrolyte solution for a proton battery of the present disclosure contains water and pyrophosphoric acid (H₄P₂O₇) dissolved in water at a concentration of 6 mol or more per kilogram of water, and does not have a freezing point at −60° C. or higher. The proton battery of the present disclosure includes the aqueous electrolyte solution of the present disclosure. The proton battery of the present disclosure includes the aqueous electrolyte solution of the present disclosure.

### CROSS-REFERENCE TO RELATED APPLICATION

This application claims priority to Japanese Patent Application No. 2023-167505 filed on Sep. 28, 2023, incorporated herein by reference in its entirety.

### BACKGROUND

### 1. Technical Field

The present disclosure relates to aqueous electrolyte solutions for proton batteries, and proton batteries.

### 2. Description of Related Art

A non-aqueous battery including a flammable non-aqueous electrolyte solution is composed of a large number of members. Therefore, the non-aqueous battery is disadvantageous in that it has a low overall energy density per volume. On the other hand, an aqueous battery including an inflammable aqueous electrolyte solution has various advantages such as an increased energy density per volume. Therefore, aqueous batteries including an aqueous electrolyte solution have been increasingly developed.

Japanese Unexamined Patent Application Publication No. 2007-194105 (JP 2007-194105 A) discloses a proton-conducting polymer battery including a positive electrode, a negative electrode, and an electrolyte solution. The electrolyte solution is an aqueous solution containing sulfuric acid as an electrolyte. Part of water contained in the electrolyte solution has been replaced with either or both of phosphoric acid and diphosphoric acid. The sulfuric acid concentration in the electrolyte solution is 3 wt % to 35 wt %, and the water concentration in the electrolyte solution is 65 wt % or less.

Japanese Unexamined Patent Application Publication No. 2019-220294 (JP 2019-220294 A) discloses an aqueous electrolyte solution for use in an aqueous potassium-ion battery. This aqueous electrolyte solution contains water and potassium pyrophosphate dissolved at a concentration of 2 mol or more per kilogram of water.

Japanese Unexamined Patent Application Publication No. 2006-164945 (JP 2006-164945 A) discloses a liquid electrolyte composed of a base A and phosphoric acid B. The molar ratio A:B is in the range of 1:3 to 1:50, and the solidification temperature is less than −30° C.

### SUMMARY

In recent years, proton batteries in which protons move between a positive electrode and a negative electrode through an electrolyte solution have been developed as an alternative secondary battery to lithium-ion secondary batteries. An aqueous electrolyte solution for such proton batteries is required to have low-temperature stability so that the batteries can be used even at extremely low temperatures such as in cold climates.

It is an object of the present disclosure to provide an aqueous electrolyte solution for a proton battery having good low-temperature stability, and a proton battery including such an aqueous electrolyte solution.

The disclosers found that the above problem can be solved by the following means.

### First Aspect

An aqueous electrolyte solution for a proton battery contains water and pyrophosphoric acid dissolved in the water at a concentration of 6 mol or more per kilogram of the water.

The aqueous electrolyte solution does not have a freezing point at −60° C. or higher.

### Second Aspect

The aqueous electrolyte solution according to the first aspect may contain the pyrophosphoric acid dissolved in the water at a concentration of 6 mol or more and 25 mol or less per kilogram of the water, or
the pyrophosphoric acid dissolved in the water at a concentration of more than 25 mol per kilogram of the water, and a potassium salt.

### Third Aspect

In the aqueous electrolyte solution according to the second aspect, the potassium salt may be a phosphate of potassium.

### Fourth Aspect

In the aqueous electrolyte solution according to the third aspect, the phosphate of potassium may be potassium pyrophosphate.

### Fifth Aspect

A proton battery includes
the aqueous electrolyte solution according to any one of the first to fourth aspects.

The present disclosure can provide an aqueous electrolyte solution for a proton battery having good low-temperature stability, and a proton battery including such an aqueous electrolyte solution.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a phase diagram showing the state of an aqueous electrolyte solution after storage in a thermostatic bath at −60° C. for a predetermined period of time; and

FIG. 2 is a DSC chart showing water (reference example), an aqueous electrolyte solution containing 10 mol of pyrophosphoric acid per kilogram of water (Example 5), an aqueous electrolyte solution containing 40 mol of pyrophosphoric acid per kilogram of water (Comparative Example 27) as measured by DSC.

### DETAILED DESCRIPTION OF EMBODIMENTS

Hereinafter, embodiments of the present disclosure will be described in detail. It should be noted that the present disclosure is not limited to the following embodiments, and various modifications can be made within the scope of the gist of the disclosure.

### Aqueous Electrolyte Solution for Proton Battery

The aqueous electrolyte solution for a proton cell of the present disclosure contains water and pyrophosphoric acid (H₄P₂O₇) dissolved in water at a concentration of 6 mol or higher per kilogram of water, and does not have a freezing point at −60° C. or higher.

The disclosers have found that an aqueous electrolyte solution for a proton battery containing pyrophosphoric acid dissolved in water at a concentration of 6 mol or more per kilogram of water has improved low-temperature stability. The reason for this is not intended to be bound by any theory, but is thought to be because the pyrophosphoric acid forms a strong hydrogen bond with water, thereby suppressing the freezing of water in the aqueous electrolyte solution.

The aqueous electrolyte solution of the present disclosure may contain pyrophosphoric acid dissolved in water at a concentration of 6 mol or more and 25 mol or less per kilogram of water.

The aqueous electrolyte solution of the present disclosure may contain pyrophosphoric acid dissolved in water at a concentration of more than 25 mol per kilogram of water, and a potassium salt.

The disclosers found that when the aqueous electrolyte solution contains pyrophosphoric acid dissolved in water at a concentration of more than 25 mol per kilogram of water, the water in the aqueous electrolyte solution tends to freeze. The reason for this is not intended to be bound by any theory, but is thought to be that the higher the concentration of the pyrophosphoric acid, the more likely the pyrophosphoric acid will form a eutectic with water. On the other hand, the disclosers found that the aqueous electrolyte solution further includes a potassium salt, so that the water in the aqueous electrolyte solution can be suppressed from freezing. The reason for this is not intended to be bound by any theory, but it is believed that the presence of the potassium salt increases the entropy of the aqueous electrolyte solution, which makes it difficult to form eutectics of a mixed solution of pyrophosphoric acid and water.

In the aqueous electrolyte solution of the present disclosure, the potassium salt may be a phosphate salt of potassium. Examples of the potassium phosphate include, but are not limited to, potassium pyrophosphate (K₄P₂O₇), tripotassium phosphate (K₃PO₄), and potassium triphosphate (K₅P₃O₁₀).

If the aqueous electrolyte solution of the present disclosure contains pyrophosphoric acid dissolved in water at a concentration of more than 25 mol per kilogram of water, the concentration of the potassium salt may be higher than 0 mol/L in terms of potassium ions, and may be less than the minimal concentration at which the potassium salt is saturated in the aqueous electrolyte solution. Since the concentration at which the potassium salt is saturated in the aqueous electrolyte solution is affected by the concentration of the pyrophosphoric acid, the concentration of the potassium salt as the potassium ion may be determined in accordance with the concentration of the pyrophosphoric acid.

The potassium ion concentration in the case where the potassium salt is potassium pyrophosphate is shown below. When the aqueous electrolyte solution contains pyrophosphoric acid dissolved in water at a concentration of 25 mol per kilogram of water, the potassium ion concentration may be higher than 0 mol/L and 3.5 mol/L or less. When the aqueous electrolyte solution contains pyrophosphoric acid dissolved in water at a concentration of 30 mol per kilogram of water, the potassium ion concentration may be higher than 0 mol/L and 1.6 mol/L or less. When the aqueous electrolyte solution contains pyrophosphoric acid in water at a concentration of 35 mol per kilogram of water, the potassium ion concentration may be higher than 0 mol/L and 1.2 mol/L or less. When the aqueous electrolyte solution contains pyrophosphoric acid dissolved in water at a concentration of 40 mol per kilogram of water, the potassium ion concentration may be higher than 0 mol/L and 1.0 mol/L or less.

In addition, the potassium ion concentration can be analyzed by, using an emission spectrometer (ICP), collecting 20 μL of the solutions, adding 1.5 mL hydrochloride, adding 100 mL of ultrapure water, and diluting and adjusting to 5000-fold. As ICP, an ICPS-8100 of Shimadzu Corporation can be used.

The fact that the aqueous electrolyte solution of the present disclosure does not have a freezing point at −60° C. or higher can be confirmed by visual observation, measurement using a differential scanning calorimeter (DSC), or the like. That is, for example, it can be confirmed by evaluating the presence or absence of freezing in the appearance observation of the aqueous electrolyte solution after holding in a constant temperature bath at −60° C. for a predetermined time. In addition, for example, an aqueous electrolyte solution can be measured by a DSC to evaluate the presence or absence of generation of suggestive heat of freezing up to −60° C. As DSC, a DSC200F3Maia manufactured by NETZSCH Corporation can be used.

As a method for preparing an aqueous electrolyte solution, a method is exemplified in which water and pyrophosphoric acid are weighed so as to have a predetermined concentration, these are mixed, and if necessary, a potassium salt is further added and mixed.

The aqueous electrolyte solution of the present disclosure is for a proton battery.

### Proton Battery

The proton battery of the present disclosure includes the aqueous electrolyte solution of the present disclosure. For the aqueous electrolyte solution, reference can be made to the above description of the aqueous electrolyte solution for the proton battery of the present disclosure.

The proton battery of the present disclosure may include a current collector and an electrode active material layer formed on the current collector.

The current collector has a function to hold the electrode active material layer, supply electric charge to the electrode active material layer, and collect electric charge from the electrode active material layer. The current collector is not particularly limited as long as it is acid-resistant and has conductivity, but it can be formed using a metal foil or a metal plate. Specifically, the current collector may be aluminum, an alloy containing aluminum as a main component, nickel, titanium, SUS, copper, or the like. The current collector may be a carbon plate, a mixture of a carbon material and a resin, or the like. The current collector may be formed by plating, surface coating, or the like of the above-described material on a base material such as iron.

Examples of the electrode active material include manganese oxide, tungsten oxide, and molybdenum oxide. Examples of the electrode active material include x-conjugated polymers such as prussian blue derivatives, MXene, polyaniline, polythiophene, polypyrrole, polyacetylene, poly-p-phenylene, polyphenylene vinylene, polyperinaphthalene, polyfuran, polyflurane, polythienylene, polypyridinediyl, polyisothianaphthene, polyquinoxaline, polypyridine, polypyrimidine, polyindole, polyaminoanthraquinone, polyimidazole, and derivatives thereof, indole-based x-conjugated compounds such as indole trimer compound, quinone-based compounds such as benzoquinone, naphthoquinone, and anthraquinone, and quinone-based polymers (those in which quinone oxygen can be conjugated to a hydroxyl group) such as polyanthraquinone, polynaphthoquinone, and polybenzoquinone. Further, examples of the electrode active material include a proton conduction type polymer obtained by copolymerization of two or more kinds of monomers that give the polymer. By doping these compounds, redox pairs are formed and conductivity is developed. These compounds are selected and used as the positive electrode active material and the negative electrode active material by appropriately adjusting the difference in the oxidation-reduction potential thereof.

The proton battery of the present disclosure may further comprise a separator. The separator may be impregnated in the aqueous electrolyte solution and disposed between the positive electrode active material layer and the negative electrode active material layer. The separator is not particularly limited as long as it is acid-resistant, can insulate between the positive electrode active material layer and the negative electrode active material layer, and has ion permeability. The separators may be, for example, polyolefin-based materials such as polyethylene and polypropylene, polytetrafluoroethylene (PTFE), cellulosic materials, aramid-based materials, amide-based materials, fiberglass-based materials, and the like.

In the present disclosure, the proton battery is a secondary battery in which protons (H⁺) move between the positive electrode active material layer and the negative electrode active material layer, and protons are inserted and desorbed in the positive electrode active material layer and the negative electrode active material layer to be charged and discharged.

In a proton battery, the protons migrate as follows: That is, during discharge, protons are desorbed from the negative electrode active material layer, and the desorbed protons move from the negative electrode active material layer to the positive electrode active material layer through the electrolyte, and protons are inserted into the positive electrode active material layer. On the other hand, during charging, protons are desorbed from the positive electrode active material layer, and the desorbed protons move from the positive electrode active material layer to the negative electrode active material layer through the electrolyte, and protons are inserted into the negative electrode active material layer.

### Preparation of Aqueous Electrolyte Solution

Water and pyrophosphoric acid were weighed into a container so as to have the concentrations shown in Table 1 below, and the container was shaken and stirred. If the concentration of the pyrophosphoric acid was higher than 25 mol per kilogram of water, potassium pyrophosphate was weighed and added to the mixture of water and pyrophosphoric acid and stirred so that the potassium ion concentration was as shown in Table 1 below. After stirring, the aqueous electrolyte solution of each example was prepared by standing in a thermostat at 25° C. for 3 days or more. The potassium ion concentration was analyzed using an emission spectrometer (ICP). Specifically, using ICPS-8100 of Shimadzu Corporation, the potassium ion concentration was analyzed by collecting 20 μL of the solutions, adding 1.5 mL hydrochloride, adding 100 mL of ultrapure water, and diluting and adjusting to 5000-fold.

### Low Temperature Stability Evaluation

### Appearance Evaluation

The aqueous electrolyte solution of each example was held in a constant temperature bath at −60° C. for 8 hours or more, and then the appearance was visually observed to confirm the presence or absence of freezing.

### Assessment by DSC

Water (Reference Example), an aqueous electrolyte solution containing 10 mol of pyrophosphoric acid per kilogram of water (Example 5), and an aqueous electrolyte solution containing 40 mol of pyrophosphoric acid per kilogram of water (Comparative Example 27) were evaluated by DSC in the following manner. That is, first, the temperature was lowered at a rate of 1° C./min from room temperature to −120° C. The temperature was then increased from −120° C. to 30° C. at a rate of 1° C./min. Thus, DSC charts were obtained. A DSC200F3Maia from NETZSCH and a container made of gold (Au) were used for the determination.

### Results

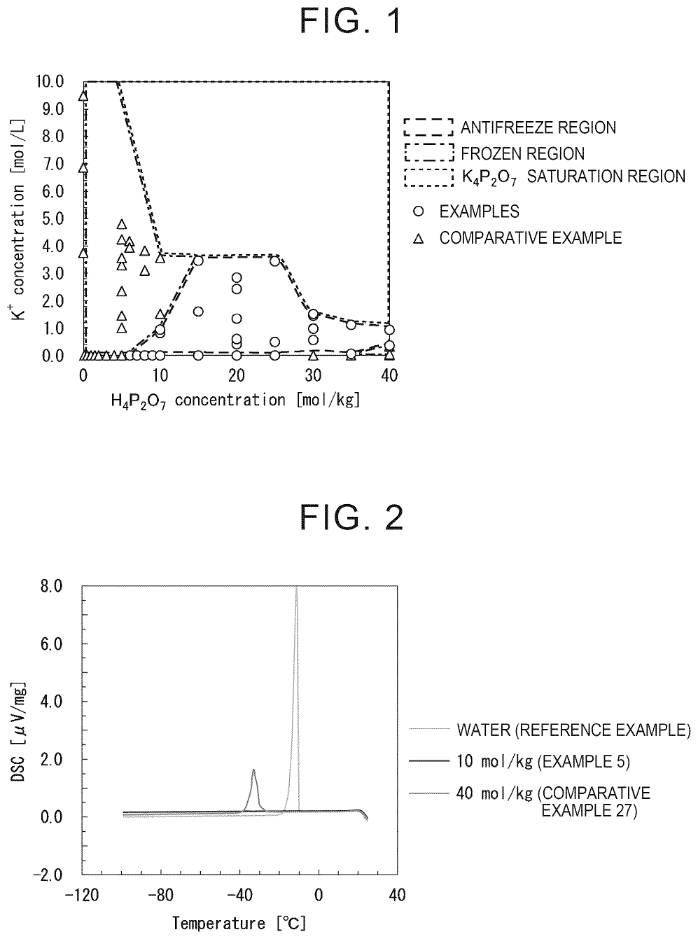

The results of the visual evaluation are shown in Table 1 and FIG. 1, and the results of the evaluation by DSC are shown in FIG. 2.

TABLE 1

| | H₄P₂O₇ | K⁺ | | | H₄P₂O₇ | K⁺ | |
|---|---|---|---|---|---|---|---|
| | concentration | density | Appearance | | concentration | density | Appearance |
| | [mol/kg] | [mol/L] | evaluation | | [mol/kg] | [mol/L] | evaluation |
| Comparative | 0 | 3.75 | Freezing | Example | 6 | 0.00 | Antifreeze |
| Example 1 | | | | 1 | | | |
| Comparative | 0 | 6.87 | Freezing | Example | 7 | 0.00 | Antifreeze |
| Example 2 | | | | 2 | | | |
| Comparative | 0 | 9.49 | Freezing | Example | 8 | 0.00 | Antifreeze |
| Example 3 | | | | 3 | | | |
| Comparative | 0.1 | 0.00 | Freezing | Example | 9 | 0.00 | Antifreeze |
| Example 4 | | | | 4 | | | |
| Comparative | 0.5 | 0.00 | Freezing | Example | 10 | 0.00 | Antifreeze |
| Example 5 | | | | 5 | | | |
| Comparative | 1 | 0.00 | Freezing | Example | 10 | 0.82 | Antifreeze |
| Example 6 | | | | 6 | | | |
| Comparative | 1.5 | 0.00 | Freezing | Example | 10 | 0.95 | Antifreeze |
| Example 7 | | | | 7 | | | |
| Comparative | 2 | 0.00 | Freezing | Example | 15 | 0.00 | Antifreeze |
| Example 8 | | | | 8 | | | |
| Comparative | 3 | 0.00 | Freezing | Example | 15 | 1.60 | Antifreeze |
| Example 9 | | | | 9 | | | |
| Comparative | 4 | 0.00 | Freezing | Example | 15 | 3.46 | Antifreeze |
| Example 10 | | | | 10 | | | |
| Comparative | 5 | 0.00 | Freezing | Example | 20 | 0.00 | Antifreeze |
| Example 11 | | | | 11 | | | |
| Comparative | 5 | 2.35 | Freezing | Example | 20 | 0.41 | Antifreeze |
| Example 12 | | | | 12 | | | |
| Comparative | 5 | 3.30 | Freezing | Example | 20 | 0.58 | Antifreeze |
| Example 13 | | | | 13 | | | |
| Comparative | 5 | 4.24 | Freezing | Example | 20 | 1.35 | Antifreeze |
| Example 14 | | | | 14 | | | |
| Comparative | 5 | 4.80 | Freezing | Example | 20 | 2.43 | Antifreeze |
| Example 15 | | | | 15 | | | |
| Comparative | 5 | 1.01 | Freezing | Example | 20 | 2.84 | Antifreeze |
| Example 16 | | | | 16 | | | |
| Comparative | 5 | 1.46 | Freezing | Example | 25 | 0.00 | Antifreeze |
| Example 17 | | | | 17 | | | |
| Comparative | 5 | 3.52 | Freezing | Example | 25 | 0.49 | Antifreeze |
| Example 18 | | | | 18 | | | |
| Comparative | 6 | 3.94 | Freezing | Example | 25 | 3.44 | Antifreeze |
| Example 19 | | | | 19 | | | |
| Comparative | 6 | 4.18 | Freezing | Example | 30 | 0.57 | Antifreeze |
| Example 20 | | | | 20 | | | |
| Comparative | 8 | 3.11 | Freezing | Example | 30 | 1.00 | Antifreeze |
| Example 21 | | | | 21 | | | |
| Comparative | 8 | 3.82 | Freezing | Example | 30 | 1.45 | Antifreeze |
| Example 22 | | | | 22 | | | |
| Comparative | 10 | 1.53 | Freezing | Example | 30 | 1.52 | Antifreeze |
| Example 23 | | | | 23 | | | |
| Comparative | 10 | 3.57 | Freezing | Example | 35 | 0.06 | Antifreeze |
| Example 24 | | | | 24 | | | |
| Comparative | 30 | 0.00 | Freezing | Example | 35 | 1.12 | Antifreeze |
| Example 25 | | | | 25 | | | |
| Comparative | 35 | 0.00 | Freezing | Example | 40 | 0.36 | Antifreeze |
| Example 26 | | | | 26 | | | |
| Comparative | 40 | 0.00 | Freezing | Example | 40 | 0.36 | Antifreeze |
| Example 27 | | | | 27 | | | |
| Comparative | 40 | 0.01 | Freezing | Example | 40 | 0.93 | Antifreeze |
| Example 28 | | | | 28 | | | |
| Comparative | 40 | 0.03 | Freezing | | | | |
| Example 29 | | | | | | | |
| Comparative | 40 | 0.06 | Freezing | | | | |
| Example 30 | | | | | | | |
| Comparative | 40 | 0.32 | Freezing | | | | |
| Example 31 | | | | | | | |
| Comparative | 40 | 0.35 | Freezing | | | | |
| Example 32 | | | | | | | |

FIG. 1 is a phase diagram showing the state of the aqueous electrolyte solution of each example after being stored in a thermostatic bath at −60° C. for a predetermined time. As shown in Table 1 and FIG. 1, an aqueous electrolyte solution containing pyrophosphoric acid dissolved in water at a concentration of 6 mol or more and 25 mol or less per kilogram of water had a non-freezing region (anti-freeze region) at −60° C. On the other hand, when the concentration of the pyrophosphoric acid was 30 mol or more and 40 mol or less per kilogram of water, the aqueous electrolyte solution that does not contain potassium pyrophosphate was frozen at −60° C. On the other hand, when the aqueous electrolyte solution contains potassium pyrophosphate, the aqueous electrolyte solution was not frozen at −60° C. even if the concentration of the pyrophosphoric acid was 30 mol or more and 40 mol or less per kilogram of water. From the above, it was suggested that the concentration range of pyrophosphoric acid capable of preparing an aqueous electrolyte solution having no freezing point at −60° C. can be expanded to a high concentration side by the aqueous electrolyte solution containing a potassium salt.

FIG. 2 is a DSC chart showing water (reference example), an aqueous electrolyte solution containing 10 mol of pyrophosphoric acid per kilogram of water (Example 5), an aqueous electrolyte solution containing 40 mol of pyrophosphoric acid per kilogram of water (Comparative Example 27) as measured by DSC. As shown in FIG. 2, in the aqueous electrolyte solution of Example 5, no suggestive heat of freezing was observed at −60° C. or higher. That is, the aqueous electrolyte solution did not have a freezing point up to −60° C. or higher. In addition, the suggestive heat of freezing was not observed in the aqueous electrolyte solution even at −100° C.

Next, an aqueous electrolyte solution of each example was prepared in the same manner as in the case of using potassium pyrophosphate, except that the potassium salt was changed from potassium pyrophosphate to tripotassium phosphate and the concentration shown in Table 2 below was obtained. The obtained aqueous electrolyte solution was subjected to the same appearance evaluation as described above. Table 2 shows the results.

TABLE 2

| | H₄P₂O₇ | | |
|---|---|---|---|
| | concentration | K⁺ density | Appearance |
| | [mol/kg] | [mol/L] | evaluation |
| Comparative | 10 | 4.41 | Freezing |
| Example 33 | | | |
| Comparative | 20 | 5.30 | Freezing |
| Example 34 | | | |
| Example 29 | 30 | 5.42 | Antifreeze |

As shown in Table 2, when tripotassium phosphate was used as the potassium salt, the aqueous electrolyte solution of the example containing 30 mol of pyrophosphoric acid per kilogram of water did not freeze at −60° C. On the other hand, the aqueous electrolyte solution of the comparative example containing 10 mol or 20 mol of pyrophosphoric acid per kilogram of water was frozen at −60° C. even if it contained tripotassium phosphate. This result is considered to support the above-mentioned reasoning that the concentration range of pyrophosphoric acid capable of preparing an aqueous electrolyte solution having no freezing point at −60° C. can be extended to a high concentration side because the aqueous electrolyte solution contains a potassium salt.

In addition, an aqueous electrolyte solution of each example was prepared in the same manner as in the case of using potassium pyrophosphate, except that the potassium salt was changed from potassium pyrophosphate to potassium triphosphate and the concentration shown in Table 3 below was obtained. The obtained aqueous electrolyte solution was subjected to the same appearance evaluation as described above. The results are shown in Table 3.

TABLE 3

| | H₄P₂O₇ | | |
|---|---|---|---|
| | Concentration | K⁺ Density | Appearance |
| | [mol/kg] | [mol/L] | Evaluation |
| Comparative | 10 | 2.63 | Freezing |
| Example 35 | | | |
| Example 30 | 20 | 2.17 | Antifreeze |
| Example 31 | 30 | 1.16 | Antifreeze |
| Example 32 | 40 | 0.67 | Antifreeze |

As shown in Table 3, when potassium triphosphate was used as the potassium salt, the aqueous electrolyte solution of the example containing 20 mol to 40 mol of pyrophosphoric acid per kilogram of water did not freeze at −60° C. In contrast, the comparative aqueous electrolyte solution containing 10 mol of pyrophosphoric acid per kilogram of water was frozen at −60° C. even if it contained potassium triphosphate. This result is believed to support the above reasoning that the concentration range of pyrophosphoric acid capable of preparing an aqueous electrolyte solution having no freezing point at −60° C. can be extended to a high concentration side because the aqueous electrolyte solution contains a potassium salt as in the case of using tripotassium phosphate as the potassium salt.

What is claimed is:

1. An aqueous electrolyte solution for a proton battery, the aqueous electrolyte solution containing
water and
pyrophosphoric acid dissolved in the water at a concentration of 6 mol or more per kilogram of the water, wherein the aqueous electrolyte solution does not have a freezing point at −60° C. or higher.

2. The aqueous electrolyte solution according to claim 1, wherein the aqueous electrolyte solution contains
the pyrophosphoric acid dissolved in the water at a concentration of 6 mol or more and 25 mol or less per kilogram of the water, or
the pyrophosphoric acid dissolved in the water at a concentration of more than 25 mol per kilogram of the water, and a potassium salt.

3. The aqueous electrolyte solution according to claim 2, wherein the potassium salt is a phosphate of potassium.

4. The aqueous electrolyte solution according to claim 3, wherein the phosphate of potassium is potassium pyrophosphate.

5. A proton battery including the aqueous electrolyte solution according to claim 1.
